(19) United States
(12) Patent Application Publication
(10) Pub. No.: US 2019/0165579 A1
(43) Pub. Date: May 30, 2019

(54) ENERGY MANAGEMENT DEVICE, ENERGY MANAGEMENT METHOD, AND PROGRAM STORAGE MEDIUM

(71) Applicant: NEC Corporation, Minato-ku, Tokyo (JP)

(72) Inventor: Masumi ICHIEN, Tokyo (JP)

(73) Assignee: NEC Corporation, Minato-ku, Tokyo (JP)

(21) Appl. No.: 16/301,803

(22) PCT Filed: May 15, 2017
(86) PCT No.: PCT/JP2017/018163

§ 371 Date: Nov. 15, 2018

(30) Foreign Application Priority Data
May 20, 2016 (JP) 2016-101540

(51) Int. Cl. H02J 3/14; G06Q 50/06; H02J 13/00

(52) U.S. Cl. CPC H02J 3/14; H02J 13/00; G06Q 50/06

(57) ABSTRACT

An energy management device acquires an actual reduction amount, which is the amount of energy that a consumer was able to reduce in a set time period, and determines a function wherein a reduction target value for the amount of energy used that has been set for the consumer is input, and an expectation index indicating an expected degree of achievement of the reduction target value is output, and wherein a higher expectation index is output as the reduction target value is lower and as the actual energy reduction amount of the consumer is higher. Furthermore, when an overall community reduction target amount is distributed to consumers in a community, the energy management device determines the reduction target value for each consumer so as to maximize the total of the expectation indexes for the consumers in the community.

### TECHNICAL FIELD

The present invention relates to a technique for, when attempting to suppress energy in an entire community, determining a highly feasible energy reduction target value for each of consumers constituting the community.

### BACKGROUND ART

A community energy management system (CEMS) is one kind of energy management system for efficient use of energy. The CEMS is a system which collectively manages energy of a plurality of consumers for purposes of reduction of an energy amount in an entire community, and efficient use of renewable energy (electric power of a storage battery or solar power generation) at each consumer. It is conceivable that a supplier of energy to a plurality of consumers, for example, a power aggregator, considerably reduces an amount of energy used (energy consumption) in an entire community by using the CEMS, and thereby lessens an energy supply load of an electric power system. In this case, the energy supplier provides such an attractive charge menu as to return a corresponding incentive to each consumer.

Various measures are considered for control of energy use in an entire community. A simple measure is to make a request to each consumer for reduction of an energy consumption, in such a way that the customer suppresses the energy consumption to a possible extent.

In order to achieve such control of an energy consumption, for example, a device disclosed in PTL 1 sets a target value of a carbon dioxide emission amount for each consumer, and calculates an evaluation value for reward computation from a result value for the target value. Moreover, a device disclosed in PTL 2 selects an appropriate consumer for requesting electricity saving based on an electric power use history of each consumer.

### CITATION LIST

### Patent Literature

[PTL 1] Japanese Patent No. 5606614

[PTL 2] Japanese Unexamined Patent Application Publication No. 2015-104137

### SUMMARY OF INVENTION

### Technical Problem

None of the techniques in the literatures described above are capable of setting an appropriate reduction target value of an energy consumption suited to a situation of each consumer.

A target value of each consumer in PTL 1 is calculated based on electricity reception and power generation energy by each consumer, and future predictive information about an adjustable range of an energy consumption. Because this target value is calculated based on the predictive information, it is concerned that an appropriate target value is not set when a situation changes or the predictive information is not accurate. Therefore, it is concerned that an energy consumption is not reduced appropriately by each consumer, and, as a consequence, reduction of an energy consumption in an entire community cannot be achieved. To begin with, the technique in PTL 2 does not notify a consumer of a specific electricity saving target value.

The present invention has been contrived in order to solve the problems described above. In other words, a main object of the present invention is to provide a technique which presents, to a consumer, a reduction target of an energy consumption adapted to a situation of the consumer belonging to a community, thereby making it easier to achieve the reduction target of the energy consumption in the entire community.

### Solution to Problem

An embodiment of an energy management device according to the present invention includes:

an index update unit that acquires a reduction performance amount and determines a function to output an expectation index by utilizing the reduction performance amount, the reduction performance amount being an energy amount that a consumer has reduced in a set period, the expectation index representing an expected degree of achievement with respect to a reduction target value of energy consumption which is set for the consumer, the function being a function in which the reduction target value is an input, and the expectation index is an output, and the function outputting the expectation index that is higher as the reduction target value is lower and as the reduction performance amount is higher; and

a setting unit that determines the reduction target value of each of the consumers in such a way that a total of the expectation indexes based on the functions determined for the consumers in a community is maximized, when the reduction target amount of energy consumption set for the entire community being a management subject including the consumer is distributed to the consumers in the community.

An embodiment of an energy management method according to the present invention includes:

acquiring a reduction performance amount and determining a function to output an expectation index by utilizing the reduction performance amount, the reduction performance amount being an energy amount that a consumer has reduced in a set period, the expectation index representing an expected degree of achievement with respect to a reduction target value of energy consumption which is set for the consumer, the function being a function in which the reduction target value is an input, and the expectation index is an output, and the function outputting the expectation index that is higher as the reduction target value is lower and as the reduction performance amount is higher; and

determining the reduction target value of each of the consumers in such a way that a total of the expectation indexes based on the functions determined for the consumers in a community is maximized, when the reduction target amount of energy consumption set for the entire community being a management subject including the consumer is distributed to the consumers in the community.

An embodiment of a program storage medium according to the present invention stores a computer program which causes a computer to execute:

acquiring a reduction performance amount and determining a function to output an expectation index by utilizing the reduction performance amount, the reduction performance amount being an energy amount that a consumer has reduced in a set period, the expectation index representing an expected degree of achievement with respect to a reduction target value of energy consumption which is set for the consumer, the function being a function in which the reduction target value is an input, and the expectation index is an output, and the function outputting the expectation index that is higher as the reduction target value is lower and as the reduction performance amount is higher; and

determining the reduction target value of each of the consumers in such a way that a total of the expectation indexes based on the functions a total of the expectation indexes based on the functions determined for the consumers in a community is maximized the consumers in a community is maximized, when the reduction target amount of energy consumption set for the entire community being a management subject including the consumer is distributed to the consumers in the community.

### Advantageous Effects of Invention

An energy management device according to the present invention presents, to a consumer, a reduction target of energy consumption adapted to a situation of the consumer belonging to a community, and thereby enables easier to achieve the reduction target of the energy consumption in the entire community.

### BRIEF DESCRIPTION OF DRAWINGS

FIG. 1 is a diagram illustrating one example of a configuration of an energy system according to a first example embodiment of the present invention.

FIG. 2 is a diagram illustrating one example of an energy use information update flow in an energy management device according to the first example embodiment of the present invention.

FIG. 3 is a diagram illustrating one example of an expectation index update flow in the energy management device according to the first example embodiment of the present invention.

FIG. 4 is a diagram illustrating one example of a target value notification flow in the energy management device according to the first example embodiment of the present invention.

FIG. 5 is a diagram illustrating one example of a configuration of an energy system according to a second example embodiment of the present invention.

FIG. 6 is a diagram illustrating one example of a home energy use information update flow in an energy management device according to the second example embodiment of the present invention.

FIG. 7 is a diagram illustrating one example of a home expectation index update flow in the energy management device according to the second example embodiment of the present invention.

FIG. 8 is a diagram illustrating one example of a home target value notification flow in the energy management device according to the second example embodiment of the present invention.

FIG. 9 is a diagram illustrating one example of a computation parameter transmission flow in the energy management device according to the second example embodiment of the present invention.

FIG. 10 is a diagram illustrating one example of a computation parameter reception flow in the energy management device according to the second example embodiment of the present invention.

FIG. 11 is a diagram illustrating one example of information about a function that outputs an expectation index.

FIG. 12 is a diagram illustrating one example of a configuration of a computer device.

FIG. 13 is a diagram illustrating one example of a configuration of a community energy management system according to a third example embodiment of the present invention.

### EXAMPLE EMBODIMENT

### First Example Embodiment

<Configuration>

A first example embodiment according to the present invention is described with reference to the drawings.

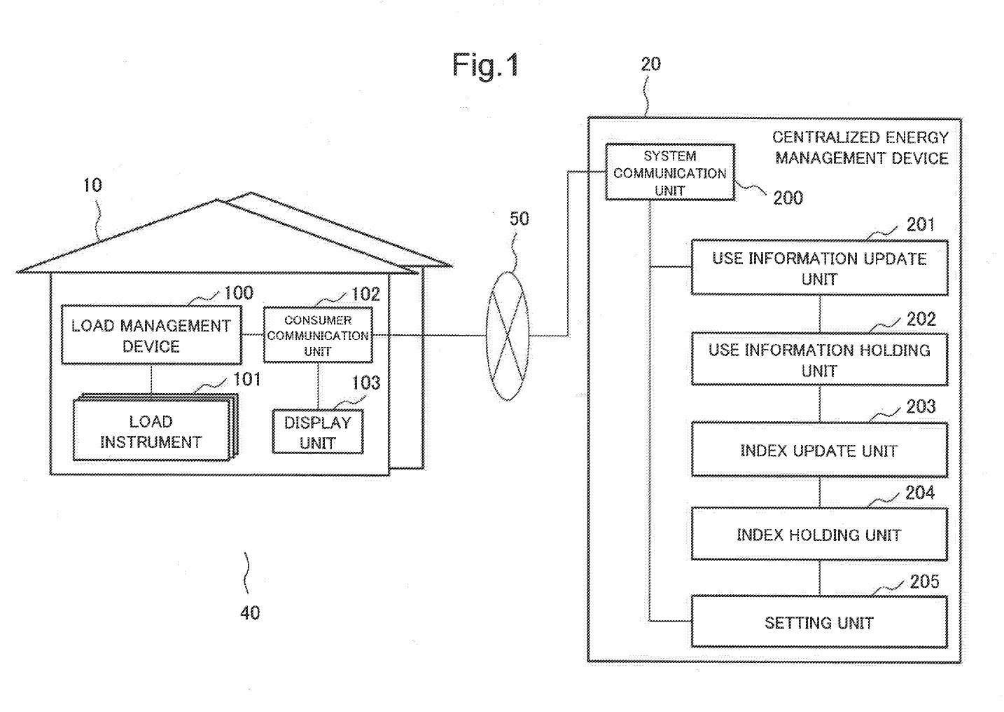

Referring to FIG. 1, an energy system 40 in the first example embodiment includes a centralized energy management device 20 and a load management device 100. The centralized energy management device 20 and the load management device 100 are connected via a communication network 50. The load management device 100 is included in a consumer 10. Note that a number of consumers 10 included in a community is not limited, but it is assumed in the description of the first example embodiment that a plurality of consumers 10 are included in one community.

The consumer 10 is a control unit of an energy demand amount in a community, and a unit of contract with, for example, an electric power company or a gas company. Specifically, the consumer 10 is, for example, a house, a store, an office, or a building using energy.

The centralized energy management device 20 is a system which manages energy use states of a plurality of consumers 10 in a community being a management subject, determines a reduction target value of energy consumption of each consumer 10, and notifies each consumer 10 thereof. Each consumer 10 is expected to comply with the notified reduction target value of energy consumption (hereinafter, a reduction target value of energy consumption is also briefly referred to as a reduction target value). However, in effect, the reduction target value is complied with in one case, or not complied with in another case. The centralized energy management device 20 determines the reduction target value that can be easily complied with for each consumer 10, under a constraint of complying with a reduction target value as the entire community.

The communication network 50 is a communication technique used between the consumer 10 and the centralized energy management device 20 for notification of energy information and the reduction target value, and is configured by a wired communication network or a wireless communication network.

The consumer 10 includes the load management device 100, a load instrument 101, a consumer communication unit 102, and a display unit 103.

The load management device 100 manages a setting state of the load instrument 101 in the consumer 10, and manages and measures the energy consumption. The load management device 100 has a function of, for example, a home energy management system (HEMS). The load instrument 101 is an instrument which uses energy in the consumer 10. The load instrument 101 is, for example, a lighting apparatus, an air conditioner, a cooking appliance, a water heater, or an audio-visual (AV) instrument.

The consumer communication unit 102 is a communication function module. The consumer communication unit 102 transmits energy use information of the load instrument 101 transmitted from the load management device 100 to the centralized energy management device 20 through the communication network 50. The consumer communication unit 102 also receives the reduction target value transmitted from the centralized energy management device 20.

The display unit 103 has a configuration of displaying information urging a resident of the consumer 10 to take an action for reduction of the energy consumption based on the reduction target value received by the consumer communication unit 102. The display unit 103 displays, for example, a current energy consumption of the entire consumer 10 and a desired energy consumption to be reduced by the consumer 10, as numerical values in an arranged form. Alternatively, the display unit 103 may display an action instruction for a person based on the reduction target value.

The centralized energy management device 20 includes a system communication unit 200, a use information update unit 201, a use information holding unit 202, an index update unit 203, an index holding unit 204, and a setting unit 205.

The system communication unit 200 has a function of receiving energy information transmitted by the consumer 10 (the load management device 100), and transmitting a reduction target value calculated by the setting unit 205 to each consumer 10.

The use information update unit 201 has a function of periodically acquiring current energy information from each consumer 10, and storing the current energy information in the use information holding unit 202.

The index update unit 203 has a function of determining a function (an output function of an expectation index) that outputs an expectation index representing a possibility that each consumer 10 can reduce an energy consumption based on the energy information periodically acquired from each consumer 10. The index update unit 203 further has a function of, whenever determining the output function of the expectation index, storing information about the determined output function of the expectation index in the index holding unit 204 (updating information about the output function of the expectation index).

Herein, the output function of the expectation index is a function determined for each consumer 10 based on a reduction performance of the energy consumption of each consumer 10, and is a function in which the reduction target value is an input (parameter), and the expectation index is an output. The output function of the expectation index outputs the expectation index representing a higher possibility when the input reduction target value is smaller. Additionally, when the same reduction target value is input to output functions of expectation indexes corresponding to the respective consumers 10 having different reduction performances of energy consumptions, the output function of the expectation index corresponding to the consumer 10 having a higher reduction performance of the energy consumption outputs the index representing a higher possibility.

The setting unit 205 has a function of periodically calculating the reduction target value of each consumer 10 by use of an energy amount that should be reduced as the entire community, and the output function of the expectation index of each consumer 10 in such a way that a total of expectation indexes of the community is maximized. The setting unit 205 also has a function of notifying each consumer 10 of the calculated reduction target value, and urging each consumer 10 to achieve the target.

Herein, the system communication unit 200, the use information update unit 201, the index update unit 203, and the setting unit 205 are each configured by a logical circuit. Moreover, the use information holding unit 202 and the index holding unit 204 are each configured by a magnetic disk device or a semiconductor storage.

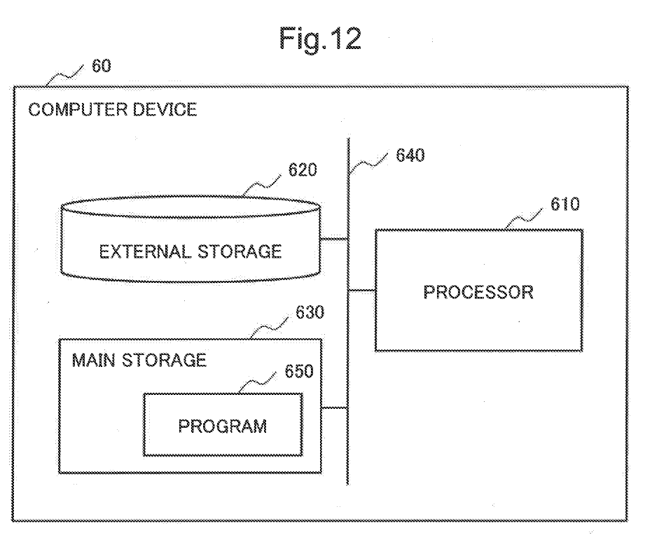

Note that the centralized energy management device 20 may be achieved by a computer device. FIG. 12 is a diagram representing a configuration example of a computer device. A computer device 60 represented in FIG. 12 includes a processor 610, a main storage 630, and an external storage 620 which are interconnected by a bus 640. The processor 610 reads and writes data from and into the main storage 630 and the external storage 620 via the bus 640. The processor 610 also executes a program 650 stored in the main storage 630. Note that the program 650 may be stored in the external storage 620 when initial setting of the computer device 60 is started, and may be loaded onto the main storage 630 from the external storage 620 by initial setting processing of the computer device 60.

Herein, the main storage 630 is a semiconductor memory device. The external storage 620 is a disk device, or a storage such as a semiconductor storage.

The processor 610 functions as the system communication unit 200, the use information update unit 201, the index update unit 203, and the setting unit 205 as represented in FIG. 1, by executing the program 650. In other words, by executing the program 650, the processor 610 executes processing performed by the system communication unit 200, the use information update unit 201, the index update unit 203, and the setting unit 205. The external storage 620 functions as the use information holding unit 202 and the index holding unit 204.

<Operation>

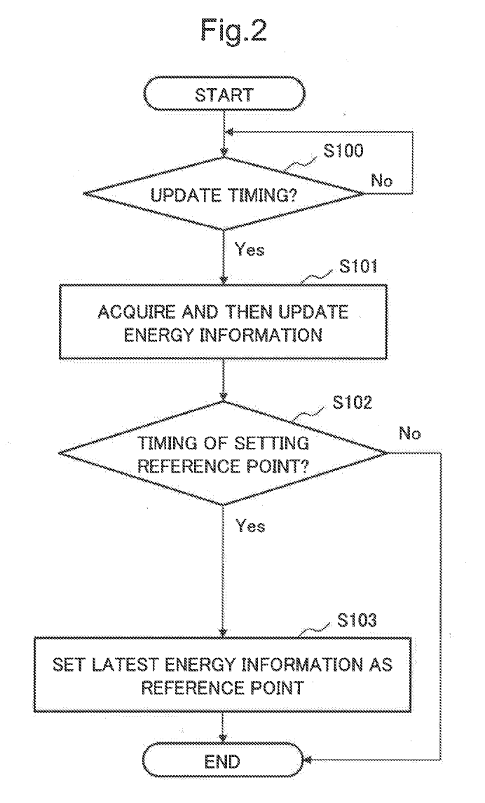

FIGS. 2 to 4 are flowcharts representing an operation example of the centralized energy management device 20. FIG. 2 is a flowchart of processing in which the use information update unit 201 updates energy use information of all the consumers 10 in the community.

First, the use information update unit 201 determines whether a update timing of energy use information is now (S100). When now is not the update timing (No in S100), the use information update unit 201 again determines, for example, after a set waiting time elapses.

Note that update processing is periodically performed, for example, at predetermined time intervals. In this case, whether now is update timing is determined by whether a predetermined time has elapsed from the previous update processing. Other timing is also determined in a similar way.

When now is the update timing (Yes in S100), the use information update unit 201 acquires a current energy consumption of each consumer 10, and stores the current energy consumption in the use information holding unit 202 as a current energy consumption (S101). The energy use information is in a form of, for example, electric power (W) or an electric power amount (Wh) which is an integrated value of electric power.

Next, the use information update unit 201 determines whether a timing of setting a reference point is now (S102). When now is not the timing (No in S102), the use information update unit 201 merely ends the processing.

When now is the timing (Yes in S102), the use information update unit 201 sets a present (latest) energy consumption of each consumer 10 as information about the reference point (S103). This reference point is used as a reference energy consumption (P_{base}_{_}ᵢ) in processing of calculating a reduction amount of the energy consumption of each consumer 10 when updating the function (the output function of the expectation index) that outputs the expectation index. The use information update unit 201 sets the reference point once, for example, at every m-th (m is a natural number of 1 or more) update.

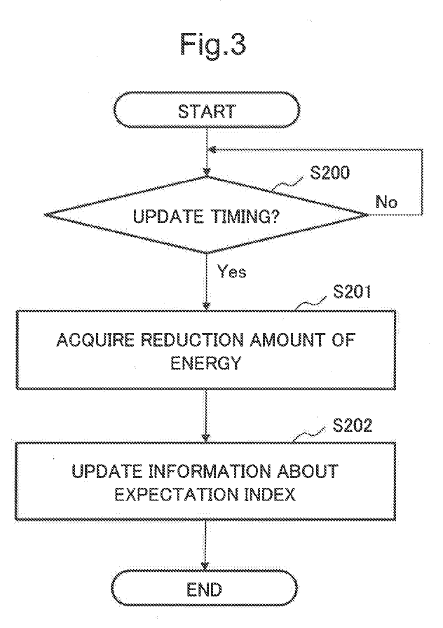

FIG. 3 is a flowchart of processing in which the index update unit 203 updates the function (the output function of the expectation index) that outputs the expectation index of each consumer 10.

First, the index update unit 203 determines whether timing of updating information about the output function of the expectation index is now (S200). When now is not the update timing (No in S200), the index update unit 203 again determines, for example, after a wait time of setting elapses.

When now is the update timing (Yes in S200), the index update unit 203 calculates the reduction amount of the energy consumption from time of acquiring the energy consumption at the reference point to the present based on the information about the current energy consumption of each consumer 10, and an energy consumption set as the reference point (S201). Then, the index update unit 203 updates the output function of the expectation index related to each consumer 10 based on the calculated reduction amount of the energy consumption, and stores information about the updated output function of the expectation index in the index holding unit 204 (S202).

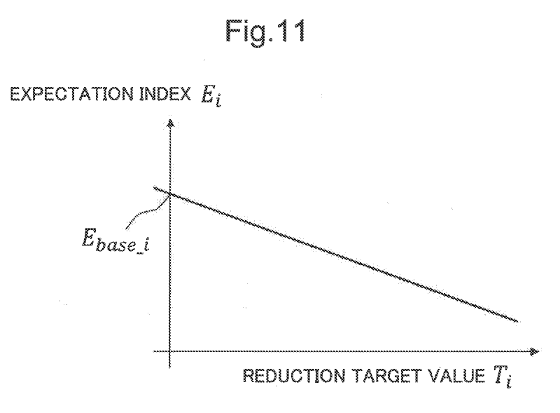

The output function of the expectation index is a function, for example, as represented in Expression (1) and FIG. 11.

Eᵢ=−(R_{base}/(P_{base}_{_}ᵢ−Pᵢ))Tᵢ+E_{base} (1)

Herein, in Expression (1), i represents an identifier of the consumer 10, for example, an ordinal number given to the consumer 10. Tᵢ represents the reduction target value (an amount to be reduced) for the consumer 10 to which the identifier i is given. Eᵢ represents the expectation index of the consumer 10 to which the identifier i is given, and represents a value representing a degree of a possibility that an energy amount corresponding to the input reduction target value Tᵢ is reduced.

Moreover, E_{base}_{_}ᵢ represents a constant number. A relation between the expectation index Eᵢ and the reduction target value Tᵢ represented by Expression (1) and FIG. 11 represents that the expectation value Eᵢ becomes higher as the reduction target value Tᵢ becomes smaller, i.e., a smaller reduction target value Tᵢ increases a possibility that the consumer 10 achieves energy reduction corresponding to the reduction target value Tᵢ.

Inclination of the function represented in FIG. 11 changes depending on an amount of energy reduced by the consumer 10. Inclination is determined by R_{base}, P_{base}_{_}ᵢ, and Pᵢ. R_{base} represents a reference value of an energy reduction amount in the entire community. P_{base}_{_}ᵢ represents a reference value of the energy consumption of the consumer 10 to which the identifier i is given. P_{base}_{_}ᵢ is a value set in S103 in the processing flow of updating the energy use information.

Pᵢ represents the current energy consumption of the consumer 10 to which the identifier i is given. Therefore, P_{base}_{_}ᵢ−Pᵢ represents the energy reduction amount from time of setting the reference point to the present, and inclination of a graph becomes gentler as the reduction amount is greater.

Note that E_{base}_{_}ᵢ and R_{base} are coefficients set by the index update unit 203, and are positive values. A predetermined maximum value of an expectation index is set for E_{base}_{_}ᵢ. R_{base} is set in such a way that Ei becomes a value equal to or more than 0 within a range of an assumed energy reduction amount and a target value.

The index update unit 203 continues periodically updating information about such coefficients constituting the output function of the expectation index based on information about the energy reduction amount.

Note that the output function of the expectation index may be not only linear but also non-linear, or may be a mapping rule that cannot be expressed as a numerical expression.

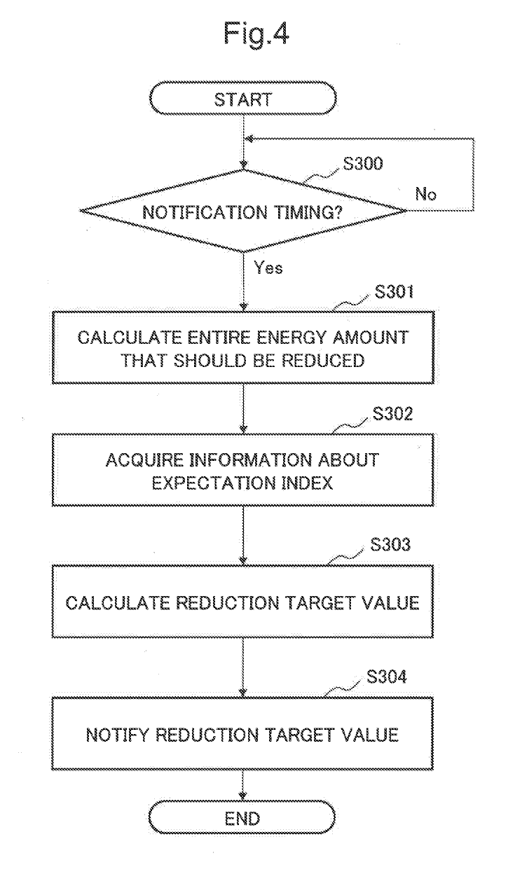

FIG. 4 is a flowchart representing processing in which the setting unit 205 notifies each consumer 10 of the target value.

The setting unit 205 first determines whether notification timing of the reduction target value is now (S300). When now is not the notification timing (No in S300), the setting unit 205 again determines, for example, after a set waiting time elapses.

When now is the notification timing (Yes in S300), the setting unit 205 calculates an amount of energy that should be reduced in the entire community (Rₜₒₜₐₗ) (S301). For example, the setting unit 205 calculates a difference between a previously set target energy consumption and a total amount of energy used at all of the consumers 10 in the community at the point of the calculation of the target energy consumption. Note that the amount of energy that should be reduced in the entire community (Rₜₒₜₐₗ) may be a predetermined fixed value.

Thereafter, the setting unit 205 acquires information about the expectation index from the index holding unit 204 (S302). For example, the setting unit 205 acquires the information about the coefficient regarding the output function of the expectation index related to each consumer 10.

Thereafter, the setting unit 205 calculates the reduction target value of each consumer 10 at which a total of expectation indexes is maximized based on the calculated amount of energy that should be reduced in the entire community, and the acquired information about the expectation index (S303). The total of expectation indexes being maximized means that a possibility of achieving the reduction target value in each consumer 10 is the highest, i.e., a possibility of achieving energy reduction in the entire community is the highest.

Then, the setting unit 205 notifies each consumer 10 of the calculated reduction target value (S304).

Herein, the calculation of the target value Tᵢ for each consumer 10 is equivalent to solving, for example, an optimization problem expressed by Expression (2) below.

$$max {\sum }_{i = 1}^{N} {E}_{i} \\ s . t . {R}_{total} = {\sum }_{i = 1}^{N} {T}_{i} \qquad ( 2 )$$

Herein, N is a total number of consumers 10 in the community. An item of max means aiming at the maximum of the total of expectation indexes for the respective consumers 10. An item of s.t. means aiming at the maximum of the total of expectation indexes under a condition in which the total of reduction target values (amounts of energy to be reduced) for the respective consumers 10 becomes equal to the desired energy amount to be reduced in the entire community (Rₜₒₜₐₗ).

Note that Rₜₒₜₐₗ represents a value calculated in S301. For example, when a relation between the expectation index and the reduction target value is linear as in Expression (1) and FIG. 11, the setting unit 205 utilizes, for example, a simplex method as a specific optimization solution.

Note that the three pieces of processing described above including the update processing of energy information in FIG. 2, the update processing of expectation index information in FIG. 3, and the notification processing of the target value in FIG. 4 may be asynchronously performed, or may be synchronously processed. For example, a certain time after the use information update unit 201 executes the processing of S103 in FIG. 2, the index update unit 203 and the setting unit 205 may successively execute the processing in FIGS. 3 and 4.

### Advantageous Effects

The centralized energy management device 20 in the first example embodiment can urge each consumer 10 to take a reasonable energy reducing action suited to a current situation, and can therefore heighten a possibility of achieving target energy reduction in the entire community.

This is because, periodically, the index update unit 203 updates information about the output function of the expectation index based on an energy reduction performance amount of each consumer 10, and the setting unit 205 calculates the reduction target value of each consumer 10 at which the expectation index is maximized.

### Second Example Embodiment

<Configuration>

A second example embodiment according to the present invention is described with reference to the drawings.

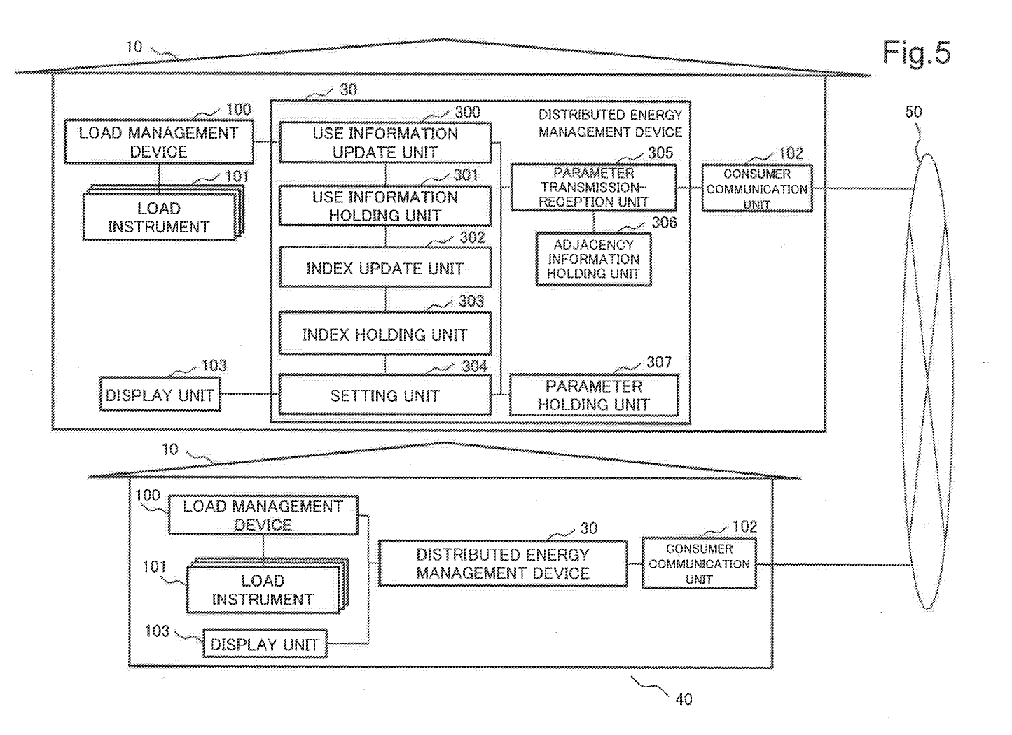

Referring to FIG. 5, an energy system 40 in the second example embodiment does not include a centralized energy management device, and has distributed energy management devices which are included in a plurality of consumers 10, respectively. The distributed energy management devices are interconnected via a communication network 50. Note that the number of consumers 10 is not limited. The communication network 50 is the same as the communication network 50 in the first example embodiment.

In the energy system 40 according to the second example embodiment, each consumer 10 corresponds to a node of a predetermined network topology (structure network). Each consumer 10 exchanges information with an adjacent node in the network topology.

The consumer 10 includes a distributed energy management device 30. Each distributed energy management device 30 calculates an optimum reduction target value through distributed processing while the adjacent consumers 10 on the network topology are communicating with each other. The above-described centralized energy management device 20 in the first example embodiment collects information about all of the consumers 10 in the community, and sets the reduction target value based on the collected information. On the other hand, the distributed energy management device 30 in the second example embodiment calculates the optimum reduction target value in the entire community through distributed processing, by information exchange between the neighboring consumers 10.

In addition to the distributed energy management device 30, the consumer 10 includes a load management device 100, a load instrument 101, a consumer communication unit 102, and a display unit 103. The load management device 100, the load instrument 101, the consumer communication unit 102, and the display unit 103 are similar to the load management device 100, the load instrument 101, the consumer communication unit 102, and the display unit 103 in the first example embodiment.

The distributed energy management device 30 includes a use information update unit 300, a use information holding unit 301, an index update unit 302, an index holding unit 303, a setting unit 304, a parameter transmission-reception unit 305, an adjacency information holding unit 306, and a parameter holding unit 307. Note that a home means the consumer 10 provided with a corresponding distributed energy management device 30.

The use information update unit 300 has a function of periodically acquiring the energy use information of home, and then recording the energy use information of home in the use information holding unit 301.

The index update unit 302 has a function of periodically acquiring the energy use information of home, determining the output function of the expectation index at home based on the information, and updating information about the output function. The index holding unit 303 holds the information about the output function of the expectation index concerning the home. Herein, the output function of the expectation index may be the same as the output function of the expectation index described in the first example embodiment.

The setting unit 304 has a function of periodically calculating and then setting the reduction target value of the home by use of information about the output function of the expectation index at home and the calculation parameter in such a way that the total of expectation indexes in the community is maximized.

The parameter transmission-reception unit 305 acquires information necessary when calculating an optimum reduction target value in a distributed way, by transmission to and reception from the adjacent consumer 10. The adjacency information holding unit 306 holds information, such as a communication address, about the consumer 10 in a relation of adjacency with the home. The parameter holding unit 307 holds the calculation parameter received from the consumer 10 in the relation of adjacency, and information about the calculation parameter updated at home.

Herein, the load management device 100, the consumer communication unit 102, the use information update unit 300, the index update unit 302, the setting unit 304, and the parameter transmission-reception unit 305 are each configured by a logical circuit. Moreover, the use information holding unit 301, the index holding unit 303, the adjacency information holding unit 306, and the parameter holding unit 307 are each configured by a magnetic disk device or a semiconductor storage.

Note that the distributed energy management device 30 may be achieved by the computer device 60 in FIG. 12.

In this case, as described in the first example embodiment, the processor 610 functions as the use information update unit 300, the index update unit 302, the setting unit 304, and the parameter transmission-reception unit 305 by executing the program 650. In other words, by executing the program 650, the processor 610 executes processing performed by the use information update unit 300, the index update unit 302, the setting unit 304, and the parameter transmission-reception unit 305. The external storage 620 functions as the use information holding unit 301, the index holding unit 303, the adjacency information holding unit 306, and the parameter holding unit 307.

<Operation>

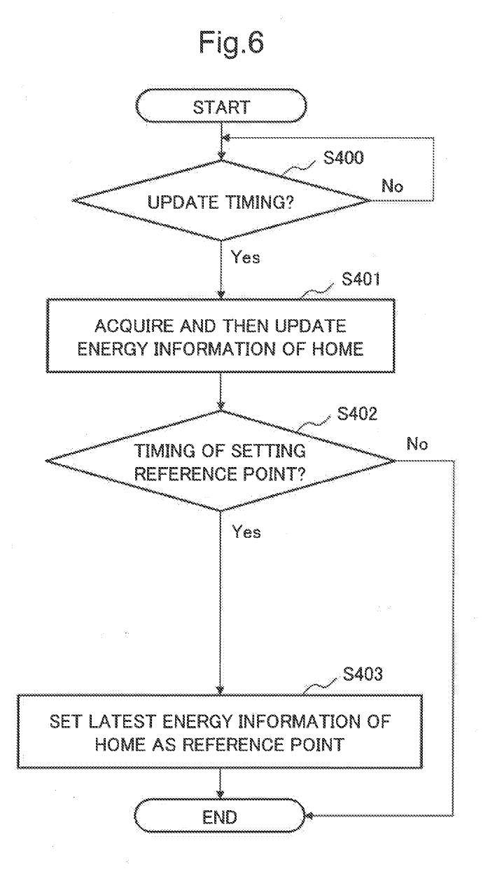

FIGS. 6 to 9 are operation flowcharts of the distributed energy management device 30. FIG. 6 is a flowchart of processing in which the use information update unit 300 updates the energy use information of home.

First, the use information update unit 300 determines whether an update timing of energy use information is now (S400). When now is not the update timing (No in S400), the use information update unit 300 again determines, for example, after a wait time of setting elapses.

When now is the update timing (Yes in S400), the use information update unit 300 acquires the current energy consumption at home, and stores the current energy consumption in the use information holding unit 301 (S401).

Thereafter, the use information update unit 300 determines whether a timing of setting the reference point is now (S402). When now is not the timing (No in S402), the use information update unit 300 merely ends the processing.

When now is the timing of setting the reference point (Yes in S402), the use information update unit 300 sets the energy consumption of home at present as information about the reference point (S403). This reference point is utilized as a reference energy consumption (P_{base}_{_}ᵢ) in processing of calculating the energy reduction amount of each consumer 10 when updating information about the output function of the expectation index. The use information update unit 300 sets the reference point once, for example, at every m-th (m is a natural number of 2 or more) update.

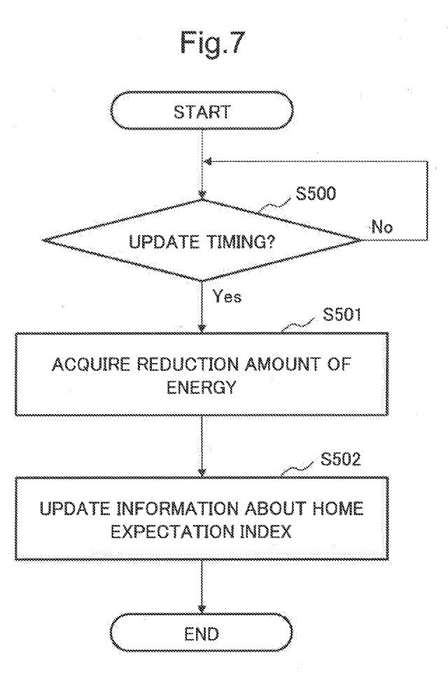

FIG. 7 is a flowchart of processing in which the index update unit 302 updates information about the output function of the expectation index concerning the home.

First, the index update unit 302 determines whether now is an update timing of information about the function (the output function of the expectation index) that outputs the expectation index (S500). When now is not the update timing (No in S500), the index update unit 302 again determines, for example, after a set waiting time elapses.

When now is the update timing (Yes in S500), the index update unit 302 calculates a difference between the current energy consumption of home and the energy consumption set as the reference point, and thereby acquires the energy reduction amount from a time of acquiring the energy consumption of the reference point to the present (S501). Then, the index update unit 302 determines the output function of the expectation index at home based on the calculated energy reduction amount, and stores information about the determined output function in the index holding unit 303 (S502).

Note that the output function of the expectation index is the same as, for example, the function (refer to Expression (1) and FIG. 11) described in the first example embodiment.

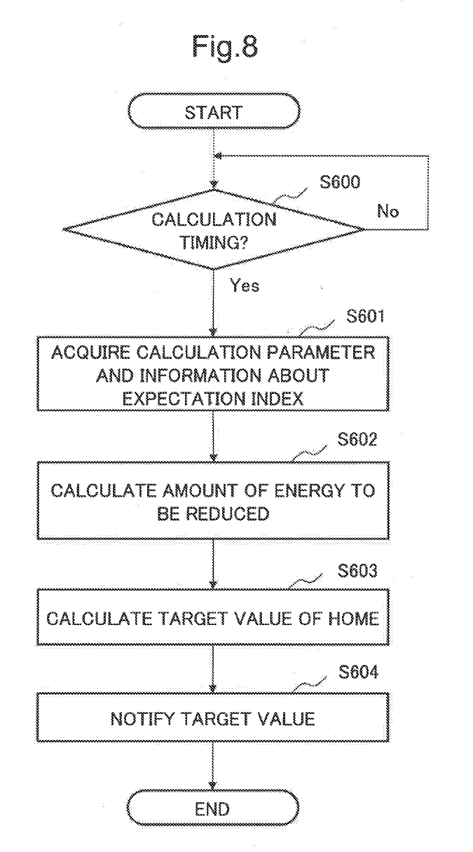

FIG. 8 is a flowchart of processing in which the setting unit 304 calculates the reduction target value of the home.

The setting unit 205 first determines whether a calculation timing of the reduction target value is now (S600). When now is not the calculation timing (No in S600), the setting unit 304 again determines, for example, after a set waiting time elapses.

When now is the calculation timing (Yes in S600), the setting unit 304 acquires, from the parameter holding unit 307, the calculation parameter received from the adjacent consumer 10, and information about the expectation index of the home from the index holding unit 303 (S601). Then, the setting unit 304 calculates the reduction target value in the entire community (S602), calculates the reduction target value of the home (S603), and notifies the display unit 103 of the calculated reduction target values (S604), for example, as described in the first example embodiment.

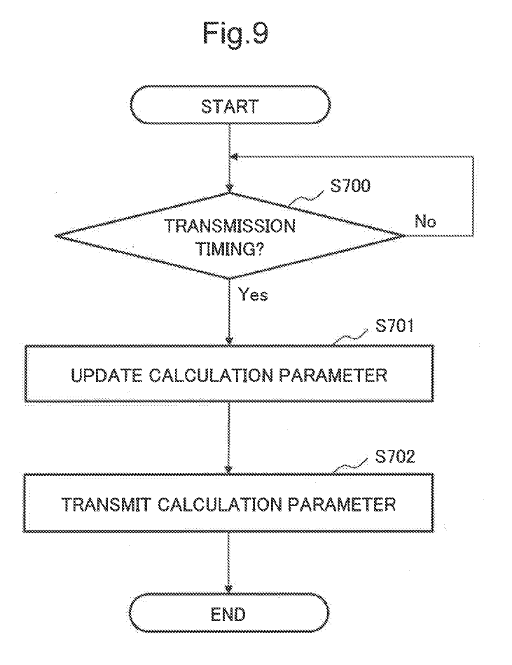

FIG. 9 is a flowchart of processing in which the parameter transmission-reception unit 305 transmits the calculation parameter.

First, the parameter transmission-reception unit 305 determines whether a transmission timing of the calculation parameter is now (S700). When now is not the transmission timing (No in S700), the parameter transmission-reception unit 305 again determines, for example, after a set waiting time elapses.

When now is the transmission timing (Yes in S700), the parameter transmission-reception unit 305 updates the calculation parameter of the home (S701), and then transmits the calculation parameter to the adjacent consumer 10 based on the information about the adjacent consumer 10 stored in the adjacency information holding unit 306 (S702).

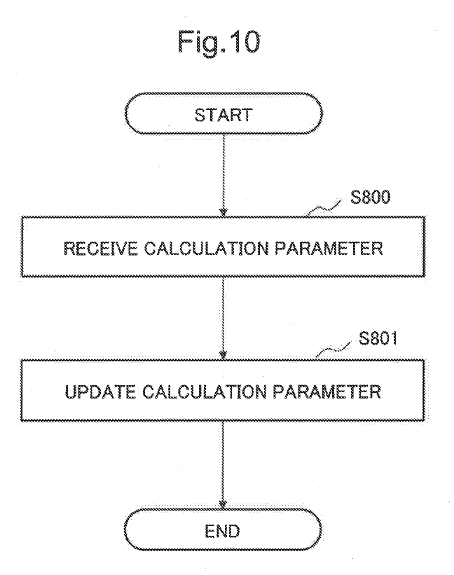

FIG. 10 is a flowchart of processing in which the parameter transmission-reception unit 305 receives the calculation parameter. The parameter transmission-reception unit 305 receives the calculation parameter from the adjacent consumer 10 (S800), and overwrites (updates) the calculation parameter on the parameter holding unit 307 (S801).

### Advantageous Effects

The distributed energy management device 30 in the second example embodiment can calculate a reasonable reduction target value suited to a situation of each consumer 10 through distributed processing with the distributed energy management device 30 provided at another consumer 10. Thereby, the distributed energy management device 30 can lessen occurrence of bottlenecks in processing performance of the energy system 40 and in safety.

Herein, another mode example (hereinafter, referred to as a modification example) in which the reduction target value in each consumer 10 is calculated by the distributed energy management device 30 provided at each consumer 10 in the community is described.

In this modification example, the setting unit 304 solves a distribution limitation optimization problem in order to calculate the reduction target value of each consumer 10. Depending on a solution algorithm thereof, a relation of adjacency with the consumer 10, contents of the calculation parameter transmitted to and received from an adjacent consumer 10 by the parameter transmission-reception unit 305, and timing at which transmission and reception are needed change.

For example, there is a distributed pseudo tree optimization procedure (DPOP) as one example of a solution algorithm of the distribution limitation optimization problem. In this solution algorithm, a tree structure is set by control subjects (in the modification example, the distributed energy management devices 30 in the community), and a partial evaluation value and an optimum variable of each control subject are exchanged along the tree structure, and an optimum solution is calculated in the entire community.

The DPOP derives the optimum solution through two steps. In the first step, information called a utility (UTIL) message which pertains to the evaluation value necessary for derivation of the optimum solution is propagated to a parent node in order from a child node of the tree structure. During propagation to the parent node, a midway node propagates the UTIL message toward the parent node while updating the UTIL message.

A root node aggregates the UTIL messages of all of the nodes, and based on the information, calculates the optimum solution of all the nodes. Next, the distributed energy management device 30 propagates the solution calculated by the root node in a reverse direction, i.e., from the parent node to the child node.

In the case of this DPOP, the calculation parameter is equivalent to the UTIL message and the notified optimum solution. Moreover, in the case of the DPOP, transmission and reception of the calculation parameter is equivalent to exchanging the UTIL message and the optimum solution between the respective nodes.

In other words, in the distributed energy management device 30 serving as the root node of the tree structure, the setting unit 304 acquires information about the output function of the expectation index at each consumer 10. This information is information aggregated in the distributed energy management device 30 being the root node through transfer of the calculation parameter between the distributed energy management devices 30.

Based on the acquired information about the output function of the expectation index, the setting unit 304 calculates the reduction target value of each consumer 10. Then, the setting unit 304 displays the reduction target value of the home on the display unit 103 of the home, and also notifies the child node side of the reduction target value of another consumer 10 in accordance with the tree structure.

In the distributed energy management device 30 serving as an intermediate node of the tree structure, the setting unit 304 specifies the reduction target value of the home from among the reduction target values notified from the parent node, and then displays the reduction target value of the home on the display unit 103 of the home. Further, the setting unit 304 notifies the child node side of the reduction target value of another consumer 10 via the parameter transmission-reception unit 305 in accordance with a subtree structure of the local device and below.

In this modification example, one of a plurality of consumers 10 in the community can be said to function in a way similar to the centralized energy management device 10 described in the first example embodiment.

Note that the distributed energy management devices 30 may form a network having a flat structure, for example, a network having a grid structure. Then, the setting unit 304 of each of the distributed energy management devices 30 may adopt such a publicly known algorithm as to work out a local optimum solution by only local information exchange, and, by repeating this, derive an overall optimum solution.

Note that the solution algorithm is not limited to the DPOP, and the distributed energy management device 30 may use another solution.

### Third Example Embodiment

A third example embodiment according to the present invention is described with reference to the drawings.

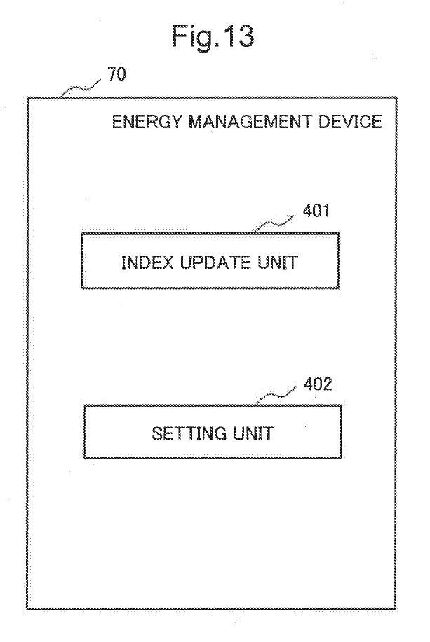

Referring to FIG. 13, an energy management device 70 in the third example embodiment includes an index update unit 401 and a setting unit 402.

The index update unit 401 acquires the reduction performance amount of the energy consumption of the consumer 10 for a certain period, and then determines, for the consumer 10, a function in which the energy reduction target value is an input, and the expectation index representing an expected degree of achievement of the energy reduction target value is an output. This function outputs a higher expectation index as the energy reduction target value is lower and as the energy reduction performance amount of the consumer 10 is higher.

The setting unit 402 distributes the given energy reduction target amount of the entire community to the consumers 10 in the community. In this instance, the setting unit 402 determines the energy reduction target value for each of the consumers 10 in such a way that a total of expectation indexes of the consumers 10 in the community obtained from the function is maximized.

The energy management device 70 in the third example embodiment can urge each consumer 10 to take a reasonable action of reducing the energy consumption suited to a current situation, and can therefore heighten a possibility of achieving target reduction of the energy consumption in the entire community.

This is because the index update unit 203 updates information about a function that outputs the expectation index based on the reduction performance amount of the energy consumption of each consumer 10, and the setting unit 205 calculates the reduction target value of each consumer 10 at which the expectation index is maximized.

While the invention of the present application has been described above with reference to the example embodiments, the invention of the present application is not limited to the example embodiments described above. Various changes that can be understood by a person skilled in the art may be made to a configuration and details of the invention of the present application within the scope of the invention of the present application.

The present invention has been described above with the above-described example embodiments as exemplars. However, the present invention is not limited to the example embodiments described above. In other words, various aspects that can be understood by a person skilled in the art may be applied to the present invention within the scope of the present invention.

This application is based upon and claims the benefit of priority from Japanese Patent Application No. 2016-101540, filed on May 20, 2016, the disclosure of which is incorporated herein in its entirety by reference.

### REFERENCE SIGNS LIST

10 Consumer
20 Centralized energy management device
30 Distributed energy management device
40 Energy system
70 Energy management device
201 Use information update unit
203, 302, 401 Index update unit
205, 304, 402 Setting unit
300 Use information update unit
610 Processor
620 External storage
630 Main storage
650 Program

What is claimed is:

1. An energy management device comprising:
a processor or a plurality of processors configured to
acquire a reduction performance amount and determine a function to output an expectation index by utilizing the reduction performance amount, the reduction performance amount being an energy amount that a consumer has reduced in a set period, the expectation index representing an expected degree of achievement with respect to a reduction target value of energy consumption which is set for the consumer, the function being a function in which the reduction target value is an input, and the expectation index is an output, and the function outputting the expectation index that is higher as the reduction target value is lower and as the reduction performance amount is higher; and
determine the reduction target value of each of the consumers in such a way that a total of the expectation indexes based on the functions determined for the consumers in a community is maximized, when the reduction target amount of energy consumption set for the entire community being a management subject including the consumer is distributed to the consumers in the community.

2. The energy management device according to claim 1, wherein the energy management device connects with each of the consumers in the community,
the processor acquires the reduction performance amount from each of the consumers in the community, and determines the function related to each of the consumers in the community using the acquired reduction performance amount, and
the processor notifies each of the consumers in the community of the reduction target value.

3-6. (canceled)

7. An energy management method comprising:
by computer,
acquiring a reduction performance amount and determining a function to output an expectation index by utilizing the reduction performance amount, the reduction performance amount being an energy amount that a consumer has reduced in a set period, the expectation index representing an expected degree of achievement with respect to a reduction target value of energy consumption which is set for the consumer, the function being a function in which the reduction target value is an input, and the expectation index is an output, and the function outputting the expectation index that is higher as the reduction target value is lower and as the reduction performance amount is higher; and
determining the reduction target value of each of the consumers in such a way that a total of the expectation indexes based on the functions determined for the consumers in a community is maximized, when the reduction target amount of energy consumption set for the entire community being a management subject including the consumer is distributed to the consumers in the community.

8. The energy management method according to claim 7, further comprising:
by computer,
acquiring the reduction performance amount from each of the consumers in the community, and determining the function related to each of the consumers in the community using the acquired reduction performance amount, and
notifying each of the consumers in the community of the reduction target value.

9. A non-transitory program storage medium storing a computer program which causes a computer to execute:
acquiring a reduction performance amount and determining a function to output an expectation index by utilizing the reduction performance amount, the reduction performance amount being an energy amount that a consumer has reduced in a set period, the expectation index representing an expected degree of achievement with respect to a reduction target value of energy consumption which is set for the consumer, the function being a function in which the reduction target value is an input, and the expectation index is an output, and the function outputting the expectation index that is higher as the reduction target value is lower and as the reduction performance amount is higher; and
determining the reduction target value of each of the consumers in such a way that a total of the expectation indexes based on the functions determined for the consumers in a community is maximized, when the reduction target amount of energy consumption set for the entire community being a management subject including the consumer is distributed to the consumers in the community.

10. The non-transitory program storage medium according to claim 9, further storing a computer program which causes
a computer connected to each of the consumers in the community to execute:
acquiring the reduction performance amount from each of the consumers in the community, and determining the function related to each of the consumers in the community using the acquired reduction performance amount, and
notifying each of the consumers in the community of the reduction target value.
